(19) United States
(12) Patent Application Publication
(10) Pub. No.: US 2024/0351241 A1
(43) Pub. Date: Oct. 24, 2024

(54) COMPRESSED CONCRETE BLOCK WITH LOW MASS PER UNIT AREA COMPRISING A RAW CLAY MATRIX AND ASSOCIATED METHODS

(71) Applicant: MATERRUP, SAINT-GEOURS-DE-MAREMNE (FR)

(72) Inventors: Manuel MERCÉ, Saint Vincent de Tyrosse (FR); Mathieu NEUVILLE, Soustons (FR)

(21) Appl. No.: 18/579,940

(22) PCT Filed: Jul. 21, 2022
(86) PCT No.: PCT/EP2022/070571

§ 371 Date: Jan. 17, 2024

(30) Foreign Application Priority Data
Jul. 21, 2021 (FR) FR2107891

(51) Int. Cl. B28B 1/08; C04B 7/12; C04B 7/153; C04B 40/00; C04B 103/00

(52) U.S. Cl. CPC B28B 1/08; C04B 7/12; C04B 7/153; C04B 40/0039; C04B 2103/008

(57) ABSTRACT

The invention concerns a compressed concrete block comprising a raw clay matrix, a calcined metal oxide composition and aggregates, said compressed concrete block having a basis weight less than or equal to 600 kg/m².

The invention further proposes a preparation method (100) for a compressed concrete block having a basis weight less than or equal to 600 kg/m², said method comprising the following steps:
mixing (110) a raw clay matrix, a calcined metal oxide composition, aggregates and water;
placing (120) the resulting mixture in molds;
applying (140) pressure to one surface of the molded mixture, preferably the top surface;
removing (160) the compressed concrete blocks from the molds, so as to obtain a compressed concrete block with a basis weight less than or equal to 600 kg/m².

### TECHNICAL FIELD

The invention concerns the field of construction and more particularly that of masonry units for use in construction. In particular, it concerns a compressed concrete block comprising a raw clay matrix. The invention also concerns a method for preparing and using the compressed concrete block.

### PRIOR ART

Hereinafter, we describe the known prior art on the basis of which the invention has been developed.

Cement is the world's second most consumed resource, with over 4 billion tons produced every year worldwide. This consumption is constantly increasing, driven by growing demand for housing and infrastructure. Cement is used in particular to precast masonry units such as precast concrete blocks (abbreviated “CMU” or “concrete masonry units”). There are over 150 different concrete block references, both in shape and composition. In particular, building designers prescribe cement agglomerates such as hollow precast concrete blocks (also known as cinder blocks). There is a particular interest in precast concrete blocks with a low basis weight (e.g., less than 600 kg/m²), such as hollow precast concrete blocks, as an alternative to boarded walls, as they use less material for the same load-bearing wall surface. This means a significant reduction in CO₂ footprint. Furthermore, precast concrete blocks offer the best quality/price ratio of all masonry units.

Depending on regional habits and specificities, the most common blocks are made of cement concrete or terracotta. Mostly inert, cement concrete blocks are generally composed of 87% aggregates (stone, gravel, sand) from local quarries, 7% cement (limestone and baked clay) and 6% water. Their average weight is usually between 10 and 25 kg (cement blocks are heavier than terracotta blocks, but cement concrete blocks are often hollow). Concrete blocks also contain Portland cement or clinkers, which are responsible for CO₂ emissions into the environment. When they contain clay, the latter is fired (metakaolin type), again resulting in CO₂ emissions linked to the energy required for firing.

Cement, generally Portland cement, is a hydraulic binder which, when mixed with water, hardens and forms a mass. Once hardened, cement retains its strength and stability, even when exposed to water. A wide variety of cements are used worldwide. Nevertheless, all conventional cements contain clinker in percentages ranging from 5% for some blast-furnace cements to a minimum of 95% for Portland cement, the world's most widely used cement today. Clinker is produced by firing a mixture of approximately 80% limestone and 20% aluminosilicates (such as clays). This process, known as clinkerization, generally takes place at temperatures in excess of 1,200° C., which means that the cement-making method is highly energy-intensive. Furthermore, the chemical conversion of limestone into lime also releases carbon dioxide. As a result, the cement industry generates around 8% of the world's CO₂ emissions.

Faced with this challenge, industry and researchers are looking into ways of reducing the carbon dioxide emissions generated by the cement industry, and in particular by the low-weight concrete block industry. Indeed, driven by their ease of use, worldwide demand for precast concrete blocks is expected to grow by more than 5% a year until 2027, reaching a market worth more than 2 billion euros in 2027.

It has recently been proposed, in the field of self-compacting concretes, to replace Portland cement with metakaolin (Saand et al., 2019. Effect of metakaolin developed from Local Soorh on Fresh Properties and Compressive Strength of Self-Compacted Concrete. Engineering, Technology & Applied Science Research. Vol. 9, No. 6, 2019, 4901-4904; Saand et al., 2021. Effect of metakaolin developed from natural material Soorh on fresh and hardened properties of self-compacting concrete. Innovative Infrastructure Solutions volume 6, Article number: 166). However, these studies show that metakaolin (i.e., fired clay) cannot completely replace Portland cement. Also in the field of self-compacting concretes, it has been proposed to replace Portland cement-based concrete with concretes based on activated metallurgical waste (Rosales et al., 2021; Alkali-Activated Stainless Steel Slag as a Cementitious Material in the Manufacture of Self-Compacting Concrete. Materials 2021, 14, 3945). Also here, in this recent study, Portland cement was only partially replaced. In addition, self-compacting concretes generally behave differently from the concretes used to make precast concrete blocks, and in particular from precast concrete blocks with low basis weight. It has also been proposed to combine clay soil with blast furnace slag, but the bricks produced required very long curing times (“Engineering properties of unfired clay masonry bricks” J. E. Oti et al. Engineering Geology 107 (2009) 130-139).

For a long time, the preparation of masonry units with a low carbon footprint was hampered by the incompatibility between the absence of Portland cement and sufficient mechanical strength to be widely used in construction. For example, patent application EP1997786 relates to gypsum-based facing boards containing a proportion of clay. Here, clay is proposed as a filler to form materials with mechanical strengths that are far too low for many applications. To address this problem, it has already been proposed to use deflocculating agents in combination with raw clay and an activator so as to achieve sufficient strength values to claim widespread use in construction (WO2020141285 and WO2020178538). However, these publications do not present a solution for the preparation of compressed concrete blocks with low basis weight (e.g., less than 600 kg/m²).

In fact, precast concrete blocks with low basis weight (e.g., less than 600 kg/m²) are formed in a specific method involving the use of a mold and a compression step. To improve the behavior of the compressed concrete block mix, particularly when designing precast concrete blocks with reduced basis weight (e.g., presence of cavities), superplasticizers from the petrochemical industry are often used, the production of which must be taken into account when calculating the carbon footprint (Dawood et al. 2010. Hollow block concrete units' production using superplasticizer and pumicite. Australian Journal of Civil Engineering. Volume 6, 2010—Issue 1). Compounds of natural origin were also proposed, but were unable to completely replace Portland cement (Samad et al., 2021. Strength properties of green concrete mixture with added palm oil fiber and its application as a load-bearing hollow block. IOP Conf. Series: Materials Science and Engineering 1144 (2021) 012031). Finally, it has been proposed to add fly ash mixtures in combination with Portland Cement and recycled aggregates (Posi et al. 2016 Preliminary Study of Pressed Lightweight Geopolymer Block Using Fly Ash, Portland Cement and Recycled Lightweight Concrete. Key Engineering Materials. Vol. 718, pp 184-190). However, these materials also require the presence of Portland cement. This is the case, for example, with patent application WO2008/003150 in the field of insulating building materials. It relates to the preparation of a low-carbon, non-combustible, low-density, recyclable building material containing cement. The proposed material has a compressive strength of 4.75 kg/cm². This is too low for many applications.

Portland cement is therefore an essential element in the manufacture of precast concrete blocks with a low basis weight (e.g., less than or equal to 600 kg/m²). There is therefore a need for precast concrete blocks with a low basis weight, a low environmental footprint and mechanical properties that are at least equivalent to, if not superior to, the mechanical properties of concrete blocks commonly used in construction (such as those defined in standards NF EN 771-3+A1/CN, NF DTU 20.1, NF DTU 20.13, NF EN 1996-1-1 and NF EN 1996-1-1/NA), on the one hand, and with good compactability to enable an industrializable manufacturing process, on the other.

The invention aims to remedy these drawbacks.

The purpose of the invention is to remedy the drawbacks of the prior art. In particular, the invention aims to provide a masonry unit, in particular a compressed concrete block, with a low basis weight, good compactability properties and a compressive strength compatible with use in the building industry.

A further purpose of the invention is to propose a preparation method of such compressed concrete blocks, said method having reduced CO₂ emissions compared with prior art methods.

### SUMMARY OF THE INVENTION

The invention aims to remedy these drawbacks.

The invention relates in particular to a compressed concrete block comprising a raw clay matrix, a calcined metal oxide composition and aggregates, said compressed concrete block having a basis weight less than or equal to 600 kg/m².

In particular, the invention relates to a compressed concrete block obtainable by a method according to the invention. Preferably, the invention also relates to a compressed concrete block obtained according to a method according to the invention. As will be described in detail, the compressed concrete block comprises a raw clay matrix, metal oxides and aggregates. In particular, the compressed concrete block has a basis weight of 600 kg/m² or less and a thickness of at least 15 cm.

The applicant has developed a preparation method of compressed concrete blocks similar to precast concrete blocks, but produced from a binder containing raw clay, in such a way as to limit the carbon footprint and offer compactability properties making industrialization possible. In combination with a calcined metal oxide composition, this raw clay is an advantageous replacement for clinker, Portland cement or fired clay.

In particular, the applicant has developed a specific mixture, namely the combined presence of raw clay with metal oxides and an activator, enabling the manufacture of compressed concrete blocks with good performance. The inventors have also developed a preparation method of a compressed concrete block which, even in the absence of a deflocculant, makes it possible to achieve sufficient mechanical strength values, i.e., at least equal to 40 kg/cm².

According to other optional features of the concrete block, the latter may optionally include one or more of the following features, alone or in combination:
it has a basis weight less than or equal to 500 kg/m², preferably less than or equal to 400 kg/m², more preferably less than or equal to 300 kg/m², more preferably less than or equal to 200 kg/m². Such blocks are easier to handle, in particular for the rapid construction of wall planes, such as facade walls or load-bearing walls.
it contains less than 2% Portland cement by weight.
it contains less than 2% by weight of clinker.
it has a density of less than or equal to 2000 kg/m³, preferably less than or equal to 1900 kg/m³, more preferably less than or equal to 1800 kg/m³.
it contains less than 5% by weight of fired clay matrix.
it comprises at least 2% by weight of raw clay matrix, preferably at least 2.5% by weight, more preferably at least 3% by weight, and even more preferably at least 4% by weight of raw clay matrix.
the raw clay matrix comprises at least one clay selected from: kaolinite, bentonite, Montmorillonite, Illite, Smectite, Chlorite, Muscovite, Hallocyte, Sepiolite, Attapulgite and Vermiculite.
at least part of the raw clay matrix corresponds to excavated soil.
at least part of the raw clay matrix corresponds to crushed raw clay and has a D50 of less than or equal to 500 μm, preferably less than or equal to 250 μm, more preferably less than or equal to 100 μm or even more preferably less than or equal to 50 μm. This crushed raw clay can constitute only part of the raw clay in the raw clay matrix and can preferably be combined with another raw clay with a different D50. This is advantageously applicable when adding a complementary raw clay when using excavated soil.
at least part of the raw clay matrix corresponds to crushed raw clay and has a D50 greater than or equal to 0.1 μm, preferably greater than or equal to 1 μm, more preferably greater than or equal to 10 μm or even more preferably greater than or equal to 20 μm, more preferably greater than 40 μm.
at least part of the raw clay matrix corresponds to crushed raw clay and has a D50 between 10 μm and 500 μm, preferably between 15 μm and 200 μm, more preferably between 20 μm and 100 μm or even more preferably between 20 μm and 50 μm.
it comprises at least 1% by weight of divalent metal oxides, preferably at least 2% by weight, more preferably at least 3% by weight. This can result in compressed concrete blocks with improved mechanical compressive strength.
it comprises an alkaline activating composition. In particular, it has been formed from a binder comprising an alkaline-activating composition.
the weight ratio of metal oxides to raw clay matrix is between 0.4 and 2.5.
the aggregates comprise mineral aggregates, the mineral aggregates preferably being selected from fillers, powders, sand, chippings, gravel and combinations thereof. In particular, the aggregates are predominantly, by weight, mineral aggregates. For example, more than 80% by weight of the aggregates are mineral aggregates.
it has one or more cavities with a volume greater than or equal to 2 cm³, preferably with a volume greater than or equal to 4 cm³, more preferably with a volume greater than or equal to 6 cm³, even more preferably with a volume greater than or equal to 8 cm³. The volumes correspond to the individual volumes of each cavity.
it has one or more cavities, preferably said cavity or cavities representing a total volume of at least 30% of the total volume of the compressed concrete block.
it comprises at least 40% by weight of aggregates, preferably mineral aggregates, preferably at least 60% by weight, more preferably at least 70% by weight, and even more preferably at least 80% by weight.
the aggregates comprise a biobased aggregate, the biobased aggregate preferably being selected from wood, preferably shavings or fibers, hemp, straw, hemp chenevotte, miscanthus, sunflower, typha, corn, flax, rice husks, wheat husks, rapeseed, algae, bamboo, cellulose wadding, defibered fabric and combinations thereof. In particular, the aggregates are predominantly, by weight, plant aggregates.

For example, more than 60% by weight of the plant aggregates.
it comprises at least 10% by weight of biobased aggregates, preferably at least 15% by weight, more preferably at least 20% by weight, and even more preferably at least 35% by weight.
it has a moisture buffer value (MBV), measured at the earliest 10 days after manufacture, greater than or equal to 0.75, preferably at least 1.
it contains a deflocculant, preferably an organic deflocculant.
the compressed concrete block has a 7-day compressive strength value, as measured by standard NF EN 771-3, of at least 4 MPa.
it has a compressive strength value, as measured by a sclerometer in accordance with standard NF EN 13791/CN, of at least 6 MPa.

According to a second object, the invention relates to a preparation method of a compressed concrete block with a basis weight less than or equal to 600 kg/m², said method comprising the following steps:
mixing a raw clay matrix, a calcined metal oxide composition, aggregates and water;
placing the resulting mixture in molds;
applying pressure to one surface of the molded mixture, preferably the top surface; and
removing the compressed concrete blocks from the molds to obtain compressed concrete blocks with a basis weight of 600 kg/m² or less.

In particular, the invention relates to a preparation method of compressed concrete blocks with a basis weight less than or equal to 600 kg/m², said method comprising the following steps:
mixing a raw clay matrix, a calcined metal oxide composition, aggregates and water; at least part of the raw clay matrix corresponds to crushed raw clay and has a D50 less than or equal to 500 μm as determined according to ASTM D422-63;
placing the resulting mixture in molds;
applying pressure to one surface of the molded mixture, preferably the top surface; and
removing the compressed concrete blocks from the molds.

Such a method can advantageously use a crushed clay matrix with a D50 preferably less than or equal to 250 μm, more preferably less than or equal to 100 μm as measured by methods known to those skilled in the art, such as the methods described by ASTM D422-63 or ASTM D6913-04. As will be illustrated, this can improve the mechanical compressive strength of the resulting compressed concrete block. In addition, it helps to homogenize the quality of the blocks produced and reduce dimensional variations.

This results in compressed concrete blocks with a basis weight less than or equal to 600 kg/m² and preferably a 7-day compressive strength greater than 0.5 MPa, as measured by standard NF EN 771-3. The compressive strength of the concrete block is advantageously greater than 2 MPa, preferably greater than 4 MPa when the aggregates are mineral aggregates. When the aggregates are plant aggregates, it is preferably greater than 0.5 MPa, and more preferably greater than 1 MPa.

According to other optional features of the method, the latter may optionally include one or more of the following features, alone or in combination:
the mixing step involves premixing the raw clay matrix and the calcined metal oxide composition to form a construction binder. This produces a homogeneous binder with well-distributed clay to improve block performance. In particular, the mixing step may include a hydration step for this premix.
the construction binder is mixed with the aggregates and water during the mixing step, preferably at a construction binder content less than or equal to 250 kg/m³ of mixture volume. Preferably, like the other measurements, this is indicated in dry weight.
the mixing step also includes the addition of an activating composition, preferably an alkaline activating composition. This addition of an activating composition is preferably carried out during the premixing step. This enables a homogeneous binder to be formed, which is then mixed with the aggregates and water.
the mixing step also includes the addition of a deflocculant, preferably an organic deflocculant. This deflocculant is preferably added during the premixing step. This enables a homogeneous binder to be formed, which is then mixed with the aggregates and water. As will be illustrated in the examples, the use of a deflocculant helps to limit the friability of the compressed concrete block.
   the weight ratio of calcined metal oxide composition to raw clay matrix is between 0.4 and 2.5.
it includes a curing step for the compressed concrete blocks obtained, preferably in a curing chamber.
it also includes a heating step, between 20° C. and 90° C., preferably between 40° C. and 80° C. This heating step is preferably included during a curing step, which can be humid, for example at over 80% relative humidity. This is intended to harden the compressed concrete blocks obtained.
the mixing step involves extruding the mixture.
the raw clay matrix comprises at least one clay selected from: Kaolinite, Bentonite, Montmorillonite, Illite, Smectite, Chlorite, Muscovite, Hallocyte, Sepiolite, Attapulgite and Vermiculite.
the raw clay matrix comprises at least one raw clay from the smectite family, and the at least one raw clay from the smectite family accounts for more than 20% by weight of the raw clay matrix. As will be described, this combines mechanical properties with moisture buffer value.
the raw clay matrix comprises at least 50% kaolinite and/or illite by dry weight. As will be described, this gives the best results in terms of setting speed and mechanical strength at 20 hours.
at least part of the raw clay matrix corresponds to an excavated soil.
at least part of the raw clay matrix corresponds to crushed raw clay and has a D50 greater than or equal to 0.1 μm as measured by ASTM D422-63. Preferably, it has a D50 greater than or equal to 1 μm, more preferably greater than or equal to 10 μm or even more preferably greater than or equal to 20 μm, more preferably greater than 40 μm. D50 can be measured by any technique known to those skilled in the art, such as ASTM D422-63 or ASTM D6913-04(2009).
at least part of the raw clay matrix corresponds to crushed raw clay and has a D50 of between 10 μm and 500 μm as measured by ASTM D422-63. Preferably, it has a D50 between 15 μm and 200 μm, more preferably between 20 μm and 100 μm or even more preferably between 20 μm and 50 μm. D50 can be measured by any technique known to those skilled in the art, such as ASTM D422-63 or ASTM D6913-04(2009).
the aggregates comprise mineral aggregates, the mineral aggregates preferably being selected from fillers, powders, sand, chippings, gravel, fossilized aggregates and combinations thereof.
the mixture comprises at least 40% by weight of mineral aggregates, preferably at least 60% by weight, more preferably at least 70% by weight, and even more preferably at least 80% by weight.
the aggregates comprise biobased aggregates, the biobased aggregates preferably being selected from wood, preferably shavings or fibers, hemp, straw, hemp chenevotte, miscanthus, sunflower, typha, maize, flax, rice husks, wheat husks, rapeseed, algae, bamboo, cellulose wadding, defibrated fabric, and combinations thereof.
the mixture comprises at least 10% by weight of biobased aggregates, preferably at least 15% by weight, more preferably at least 20% by weight, and even more preferably at least 35% by weight.

According to a third object, the invention relates to a use of a compressed concrete block according to the invention for masonry construction; in complement with a mortar which can advantageously be formulated from a raw clay-based binder, preferably a binder comprising at least 20% by weight of raw clay such as those defined in WO2020141285 and WO2020178538.

According to a fourth object, the invention relates to a masonry construction comprising a plurality of compressed concrete blocks according to the invention. The masonry according to the invention may, for example, take the form of a facade wall or a load-bearing wall.

### BRIEF DESCRIPTION OF THE DRAWINGS

Other features and advantages of the invention will become clearer from the description that follows, with reference to the attached drawings, which are illustrative and by no means limiting.

FIG. 1 shows a schematic diagram of a preparation method of construction unit according to the invention, preferably a compressed concrete block.

FIG. 2 shows an illustration of compressed concrete blocks according to the present invention.

FIG. 3 shows an illustration of compressed concrete blocks according to the present invention.

The figures do not necessarily respect scales, particularly in thickness, and this is for illustrative purposes.

Aspects of the present invention are described with reference to flow charts and/or block diagrams of methods, apparatus (systems) and computer program products according to embodiments of the invention.

In the figures, flowcharts and block diagrams illustrate the architecture, functionality and operation of possible implementations of systems, methods and products according to various embodiments of the present invention. In this respect, each block in the flowcharts or block diagrams may represent a system, or a device. In some implementations, the functions associated with the blocks may appear in a different order than shown in the figures. For example, two blocks shown in succession may, in fact, correspond to actions performed substantially simultaneously. Each block in the block diagrams and/or flowchart, and combinations of blocks in the block diagrams and/or flowchart, can be implemented by special hardware systems that perform the specified functions or actions.

### DESCRIPTION OF EMBODIMENTS

The following is a summary of the invention and the associated vocabulary, followed by a description of the drawbacks of the prior art, and then a more detailed description of how the invention remedies them.

In the rest of the description, the term “% by weight” in connection with the masonry unit, or alternatively in connection with the compressed concrete block, is to be understood as being a proportion in relation to the dry weight of the masonry unit or compressed concrete block. The dry weight corresponds to the weight before the addition of water, for example, required to form the masonry unit. When % by weight values are given in intervals, the limits are included.

By “clay matrix” we mean one or more rock materials based on hydrated silicates or aluminosilicates with a lamellar structure, said clay matrix being composed of fine particles generally derived from the alteration of silicates with a three-dimensional structure, such as feldspars. A clay matrix may thus comprise a mixture of such rock materials which may, for example, consist of kaolinite, illite, smectite, bentonite, chlorite, vermiculite, or mixtures thereof.

By “concrete” we mean a mixture of aggregates, possibly sand, with a construction binder (e.g., cement) and water, which has set. Thus, for the purposes of the invention, a concrete block can be defined as a construction unit formed from a mixture of mineral or plant aggregates, including sand, with a construction binder and water.

For the purposes of the invention, by “raw clay matrix” we mean a clay matrix that has not undergone any calcination step. In particular, this means that it has not been subjected to any prior heat treatment. For example, this corresponds to a clay matrix that has not undergone a temperature rise above 300° C., preferably above 200° C. and more preferably above 150° C. Indeed, the raw clay matrix may undergo a heating step requiring a temperature rise generally equal to or less than 150° C., but no calcination step. A raw clay matrix can preferably comprise a mixture of rocky materials which may, for example, comprise kaolinite, illite, smectite, micas such as muscovite, bentonite, chlorite, vermiculite, or mixtures thereof.

For the purposes of the invention, a “deflocculating agent”, “deflocculant” or “deflocculating agent” may correspond to a compound capable of dissociating aggregates and colloids, particularly in aqueous suspension. Deflocculating agents have, for example, been used in the context of oil drilling or extraction to make clay more fluid and facilitate extraction or drilling.

The expression “metal oxide composition” may refer, for the purposes of the invention, to a composition comprising metal oxides such as aluminates. In particular, the metal oxide composition comprises more than 25% by weight of metal oxides, preferably more than 30% by weight of metal oxides, more preferably more than 40% by weight of metal oxides and even more preferably more than 45% by weight of metal oxides. For example, the metal oxide composition comprises more than 2% by weight of aluminate, preferably more than 5% by weight of aluminate, more preferably more than 7% by weight of aluminate and even more preferably more than 10% by weight of aluminate. In addition, the metal oxides may correspond to, or comprise, alkaline earth oxides. For example, the metal oxide composition may comprise more than 10% by weight of calcium oxide, preferably more than 20% by weight of calcium oxide, more preferably more than 25% by weight of calcium oxide and even more preferably more than 30% by dry weight of calcium oxide. The metal oxide composition may comprise chemical species that are not metal oxides. For example, the metal oxide composition may comprise metalloid oxides with, for example, more than 10% by weight of metalloid oxide, preferably more than 20% by weight of metalloid oxide, more preferably more than 25% by weight of metalloid oxide and even more preferably more than 30% by weight of metalloid oxide. These mass concentrations can be easily measured by those skilled in the art using conventional metal oxide or metalloid oxide assay techniques. In particular, the expression “metal oxide composition” refers to a composition comprising more than 50%, preferably more than 70%, more preferably more than 80% and even more preferably more than 90% of metal oxides and/or metalloid oxides, including aluminates. Preferably, a metal oxide composition will correspond to a metallurgical slag, such as blast furnace slag or fly ash. As will be explained below, the “metal oxide composition” is preferably a calcined metal oxide composition. That is, it has undergone a high-temperature step. This high-temperature step may be natural or artificial, in which case it is a high-temperature treatment. The high-temperature step may, for example, correspond to treatment at a temperature greater than or equal to 500° C., preferably greater than or equal to 750° C. and more preferably greater than or equal to 900° C.; and even more preferably greater than 1000° C. The metal oxide composition of a composition or building component can be determined by X-ray diffractometry (“X-ray Diffraction-Based Quantification of Amorphous Phase in Alkali-Activated Blast Furnace Slag” June 2021 Advances in Civil Engineering Materials; “Iron speciation in blast furnace slag cements” Cement and Concrete Research, Volume 140, February 2021, 106287).

The term “binder” or “construction binder” for the purposes of the invention can be understood as a formulation that ensures the agglomeration of materials with one another, particularly during the setting and subsequent hardening of a construction material. In particular, it enables sand and other aggregates to agglomerate with the binder constituents. The binder according to the invention is in particular a hydraulic binder, i.e., it hardens in contact with water.

The term “Portland cement” refers to a hydraulic binder composed mainly of hydraulic calcium silicates, set and hardened by a chemical reaction with water. Portland cement generally contains at least 95% clinker and a maximum of 5% secondary constituents such as alkalis (Na₂O, K₂O), magnesia (MgO), gypsum (CaSO₄-2H₂O) and various traces of metals.

The term “moisture buffer value” (MBV) refers to a material's capacity to exchange moisture with its environment. It enables us to estimate the dynamic hygrothermal behavior of the material in question, and is used to determine thermal comfort in the construction sector, and more specifically to regulate the interior humidity of a room or building. For example, in the case of a compressed concrete block, the MBV will relate to the concrete making up the block and not to the block as a whole. MBV is expressed in g/m².% RH and indicates the average quantity of water that is exchanged by sorption or desorption when material surfaces are subjected to variations in relative humidity (RH) over a given time. The moisture buffer value can be measured by any method known to those skilled in the art. For example, those skilled in the art may refer to the method described in “Durability and hygroscopic behavior of biopolymer stabilized earthen construction materials” Construction and Building Materials 259 (2020). In particular, the samples (concrete for compressed concrete block according to the invention) can be placed in a climatic chamber at 23° C. and 33% relative humidity and left until they have a constant mass (e.g., a climatic chamber model MHE 612). Under these conditions, the samples are equilibrated after 15 days' storage. The samples are then exposed to cycles of high humidity (75% RH for 8 h) followed by a cycle of low relative humidity (33% RH for 16 h). Samples are weighed at regular intervals using a laboratory balance accurate to 0.01 g. After two stable cycles, the samples are removed from the climatic chamber.

$$MBV = \frac{Δ m}{S \times Δ \% RH} \qquad [ MATH 1 ]$$

where Δm is the change in sample mass due to the change in relative humidity,
S is the total exposure surface and Δ % RH is the difference between humidity levels.

The term “substantially equal” in the context of the invention refers to a value varying by less than 20% from the compared value, preferably by less than 10%, even more preferably by less than 5%.

For the purposes of the invention, the term “excavated clay soil” refers to clay soil obtained following a step in which the soil has been dug up, for example during grading and/or earthmoving operations, with a view to construction, building or backfilling. In particular, for the purposes of the invention, the excavated clay soil may or may not be moved away from the production site. Preferably and according to an advantage of the invention, the excavated soil is used on the production site or at a distance of less than 200 km, preferably less than 50 km. Furthermore, advantageously, the clay soil excavated within the framework of the invention is a raw excavated clay soil, i.e., it has not undergone a calcination step. In particular, it has not undergone any prior heat treatment. For example, this corresponds to a clay soil that has not undergone a temperature rise above 300° C., preferably above 200° C. and more preferably above 150° C. Indeed, raw clay may undergo a drying step requiring a temperature rise generally equal to 150° C., but no calcination step. A calcination step may, for example, involve heat treatment at over 600° C. for several seconds. Conventionally used clay has a relatively constant particle size profile, with sizes below 2 μm. Excavated clay soil can have different particle size profiles. In the context of the invention, an excavated clay may comprise particles larger than 2 μm, preferably larger than 20 μm, more preferably larger than 50 μm and, for example, larger than 75 μm as determined in accordance with ASTM D422-63. Preferably, the excavated clay soil does not contain any aggregate larger than 2 cm in size, as determined in accordance with standard NF EN 933-1.

The term “clinker” refers to a constituent of cement, produced by firing a mixture of approximately 80% limestone and 20% aluminosilicates (such as clays). This process, known as clinkerization, generally takes place at temperatures in excess of 1,200° C., which is particularly energy-intensive and generates high levels of greenhouse gas emissions. Clinker is generally ground and then additivated with blast furnace slag to produce cement.

The term “D50” corresponds to the median diameter at which 50% (by volume or mass, preferably by volume) of the grains, particles, aggregates or sediments are smaller than a given diameter. For example, if D50=5.8 mm, then 50% of the particles in the sample (by volume or mass, preferably by volume) are larger than 5.8 mm and 50% are smaller than 5.8 mm. D50 is generally used to represent the particle size of a group of particles. D50 can be measured by any method known to those skilled in the art. D50 is preferably measured in accordance with ASTM D422-63 or ASTM D6913-04(2009).

For the purposes of the invention, the term “basis weight” can refer to a mass per unit area. Its unit of measurement in the International System of Units is the kilogram per square meter (kg/m² or kg m⁻²). In the context of the invention, it is used to express the mass of compressed concrete blocks as a function of the construction surface concerned (e.g., the surface of a wall section). For example, a 20*20*50 concrete block compressed according to the invention will have a surface area of 1000 cm². This means that 10 compressed concrete blocks are needed to make 1 m² of surface area. If the compressed concrete blocks weigh 20 kg each, then the surface mass of the compressed concrete blocks according to the invention will be 200 kg/m².

For the purposes of the invention, the term “density” can refer to the mass ratio of a compressed concrete block to its volume. In particular, the mass of the concrete used is considered in relation to its volume.

The construction industry needs to evolve in order to optimize its productivity while responding to societal and environmental challenges. In this context, research laboratories and manufacturers have proposed mixtures for compressed concrete blocks with reduced quantities of Portland cement. However, these mixtures always contained at least 2% Portland cement by weight.

Indeed, even when using activated fly ash for self-placing concretes, the mixtures contained at least 300 kg/m³ of Portland cement. This made it possible to maintain block compaction and concrete compactability.

However, there is an urgent need to reduce the carbon footprint of the construction sector, and the removal of Portland cement from compressed concrete blocks could speed up the sector's transition. In response, the inventors have developed new compressed concrete blocks with reduced basis weight, which can dispense with the presence of Portland cement while offering high compaction qualities.

Thus, the invention relates in particular to a compressed concrete block comprising a raw clay matrix, a calcined metal oxide composition and aggregates. In addition, this compressed concrete block advantageously has a basis weight less than or equal to 600 kg/m².

As will be shown in the examples, a compressed concrete block according to the invention has a high amount of raw clay matrix, a 7-day mechanical strength generally greater than or equal to 20 kg/cm², preferably greater than or equal to 30 kg/cm², more preferably greater than or equal to 40 kg/cm² measured in accordance with standard NF EN 771-3/CN, and for certain embodiments, an MBV greater than 0.7, preferably greater than 1, more preferably greater than 1.3 and even more preferably greater than 1.5.

The general and preferred characteristics of each of the constituents of a compressed concrete block according to the invention will be presented in detail. These embodiments are as applicable to the compressed concrete block according to the invention as to other aspects of the present invention such as the preparation methods according to the invention, the building incorporating a masonry unit according to the invention or the use of a masonry unit according to the invention.

According to a first aspect, the invention relates to a masonry unit and in particular to a compressed concrete block. Furthermore, the invention relates to a masonry unit obtained, or capable of being obtained, from a preparation method according to the present invention.

Preferably, the masonry unit will be at least 5 cm wide, at least 15 cm high and at least 30 cm long. In this way, the masonry unit or compressed concrete block can take the form of a screen wall.

The masonry unit may also have a width (or thickness) of at least 10 cm, preferably at least 15 cm, more preferably at least 20 cm. For example, the compressed concrete block may take the form of a cinder block measuring approximately 50×20×15 cm or 50×20×20 cm. In this way, the construction unit can be used to build exterior walls. Depending on the intended construction, the walls formed with the masonry units may be load-bearing walls or may be coupled to a post-and-beam framework, for example made of wood or reinforced concrete.

Alternatively, the masonry unit can take the form of bricks with, for example, the following dimensions width of at least 5 cm, height of at least 5 cm and length of at least 20 cm.

As already mentioned, and as will be illustrated in the examples, the masonry unit advantageously does not include Portland cement. However, the masonry unit would still be new to the literature if, unlike the solutions proposed for compressed concrete blocks, it contained small amounts of Portland cement. Thus, the masonry unit comprises no Portland cement or it comprises, for example, less than 5% by weight of Portland cement, preferably less than 4% by weight of Portland cement, more preferably less than 2% by weight of Portland cement, and even more preferably less than 1% by weight of Portland cement (i.e., from 0% to <1%).

Similarly, the masonry unit advantageously contains no clinker. However, the masonry unit would still be new to the literature if, unlike the solutions proposed for compressed concrete blocks, it contained small amounts of clinker. Thus, the masonry unit comprises no clinker or it comprises, for example, less than 5% by weight of Clinker, preferably less than 4% by weight of Clinker, more preferably less than 2% by weight of Clinker, and even more preferably the masonry unit comprises less than 1% by weight of Clinker (i.e., from 0% to <1%).

Fired clay has been proposed as a replacement for Portland cement. However, fired clay requires temperature rise steps which have an impact on the carbon footprint of the materials incorporating it. So, advantageously, the masonry unit does not include fired clay.

In particular, the masonry unit comprises no fired clay or comprises, for example, less than 5% by weight of fired clay, preferably less than 4% by weight of fired clay, more preferably less than 2% by weight of fired clay, and even more preferably the masonry unit comprises less than 1% by weight of fired clay (i.e., from 0% to <1%).

Preferably, the masonry unit according to the invention has a 7-day on-cylinder compressive strength value, as measured by standard NF EN 771-3, of at least 4 MPa.

Preferably, the masonry unit according to the invention has a compressive strength value based on sclerometric index measurements, such as according to standard NF EN 13791/CN, of at least 10 MPa, preferably 12, even more preferably 15 MPa.

As will be shown in the examples, the masonry unit according to the invention, in particular the compressed concrete block, has a basis weight less than or equal to 600 kg/m². Such a basis weight, in combination with the presence of raw clay, makes it possible to reduce the carbon footprint of a construction based on a masonry unit according to the invention.

Preferably, the basis weight of the masonry unit according to the invention, in particular the compressed concrete block, is less than or equal to 400 kg/m², more preferably less than or equal to 300 kg/m², most preferably less than or equal to 200 kg/m².

Preferably, the basis weight of the masonry unit according to the invention, in particular the compressed concrete block, is greater than or equal to 20 kg/m².

For example, the basis weight of the masonry unit according to the invention can be between 10 kg/m² and 600 kg/m², preferably between 20 kg/m² and 500 kg/m², and even more preferably 30 kg/m² and 400 kg/m².

In addition to a low basis weight, the concrete constituting a compressed concrete block according to the invention may have a reduced density compared with other compressed concrete blocks. In particular, the concrete constituting the compressed concrete block according to the invention may have a density less than or equal to 2000 kg/m³, preferably less than or equal to 1900 kg/m³, more preferably less than or equal to 1800 kg/m³.

In particular, the masonry unit according to the invention may have one or more cavities. Indeed, the basis weight of a masonry unit according to the present invention may be achieved by the presence of very low-density aggregate or by the presence of one or more cavities. The presence of very low-density aggregates or one or more cavities requires good compaction properties, which are made possible by the present invention.

Preferably, the cavity or cavities have a total volume of at least 30% of the total volume of the masonry unit as defined by the planes forming the periphery of the masonry unit. More preferably, the cavity or cavities have a total volume of at least 45% of the total volume of the masonry unit, and even more preferably at least 60% of the total volume.

The cavity or cavities may be open or closed. Preferably, the cavities will have a single opening. More preferably, the masonry unit will comprise a plurality of open cavities, said open cavities preferably having a single opening. Alternatively, the masonry unit will have several closed cavities.

As already mentioned, the masonry unit according to the present invention comprises a raw clay matrix, a calcined metal oxide composition and aggregates. In particular, the masonry unit according to the present invention has been formed from a raw clay matrix, a calcined metal oxide composition and aggregates. Thus, a masonry unit according to the present invention will logically comprise a raw clay matrix, metal oxides and aggregates. These elements will be described in greater detail below.

### Raw Clay Matrix

The raw clay matrix may, for example, comprise at least one mineral species selected from Illite, Kaolinite, Smectite, Bentonite, Vermiculite, Chlorite, Muscovite, Halloysite, Sepiolite and Attapulgite. The smectite family includes montmorillonite and bentonite.

Preferably, the raw clay matrix comprises at least two types of clay selected from Illite, Kaolinite, Smectite, Bentonite, Vermiculite, Chlorite, Muscovite, Halloysite, Sepiolite and Attapulgite. This includes so-called interstratified clays, which are complex combinations of several clays. Even more preferably, the raw clay matrix comprises at least one mineral species selected from: Kaolinite, Illite, Smectite, Bentonite, Chlorite and Vermiculite.

Table 1 below shows the chemical characteristics of these mineral species.

TABLE 1

| | Type of Clay | Composition |
|---|---|---|
| Raw Clay | Illite | (K, H₃O)(Al, Mg, Fe)₂(Si, Al)₄O₁₀[(OH)₂, (H₂O)] |
| Matrix | Smectite | (Na, Ca)_{0.3}(Al, Mg)₂Si₄O₁₀(OH)₂, n H₂O |
| | Kaolinite | Al₂Si₂O₅(OH)₄ |
| | Bentonite | (Na, Ca)_{0.3}(Al, Mg)₂Si₄O₁₀(OH)₂ |
| | Vermiculite | (Mg, Ca)_{0.7}(Mg, Fe, Al)₆(Al, Si)₈O₂₂(OH)₄, n H₂O |
| | Chlorite | (Fe, Mg, Al)₆(Si, Al)₄O₁₀(OH)₈ |
| | Muscovite | KAl₂(AlSi₃O₁₀) (OH, F)₂ |
| | Halloysite | Al₂Si₂O₅(OH)₄ |
| | Sepiolite | Mg₄Si₆0₁₅(OH)₂, n H₂O |
| | Attapulgite | (Mg, Al, Fe³⁺)₅[Si₈O₂₀](OH)₂ (OH2)₄ n H₂O |

As already explained, according to a preferred mode, a construction binder and then a masonry unit according to the invention will comprise at least two different types of clay and will comprise smectite, kaolinite, and/or illite.

The type of clay can be determined by methods known to those skilled in the art. In particular, X-ray diffractometry can be used. For example, the following conditions may be used:
Apparatus: Diffractometer, e.g., a BRUKER D8 ADVANCE (Bragg-Brentano geometry); e.g., with the following settings: Copper tube (λ Kα1˜ 1.54 Å) Generator power: 40 kV, 40 mA; Primary optics: 0.16° fixed slit; 2.5° Soller slit; Secondary optics: 2.5° Soller slit; LynXeye XE-T detector.
Acquisition parameters: Scan from 4 to 90° 2θ; Scan speed 0.03°2θ/second; Counting time: 480 seconds per step; Rotating sample.

For example, a masonry unit according to the invention, in particular the compressed concrete block according to the invention, comprises at least 1% by weight of raw clay matrix, preferably at least 2% by weight of raw clay matrix, more preferably at least 3% by weight of raw clay matrix and even more preferably at least 4% by weight of raw clay matrix, for example, at least 5% by weight of raw clay matrix or at least 10% by weight of raw clay matrix. In particular, the inventors have succeeded in producing compressed concrete blocks with an improved visual appearance compared with conventional compressed concrete blocks thanks to the addition of a raw clay matrix. Furthermore, a binder used to form a masonry unit according to the invention, in particular the compressed concrete block according to the invention, may comprise at least 5% by weight of raw clay matrix, preferably at least 10% by weight of raw clay matrix, more preferably at least 15% by weight of raw clay matrix and even more preferably at least 20% by weight of raw clay matrix, for example, at least 25% by weight of raw clay matrix or at least 30% by weight of raw clay matrix.

Furthermore, a masonry unit according to the invention, in particular the compressed concrete block according to the invention, preferably comprises at most 90% by weight of raw clay matrix, more preferably at most 80% by weight of raw clay matrix, more preferably at most 70% by weight of raw clay matrix, more preferably at most 60% by weight of raw clay matrix. Such quantities of raw clay matrix can be achieved in particular when the raw clay matrix corresponds to excavated clay soil. Furthermore, a binder used to form a masonry unit according to the invention, in particular the compressed concrete block according to the invention, may comprise at most 60% by weight of raw clay matrix, preferably at most 55% by weight of raw clay matrix, more preferably at most 50% by weight of raw clay matrix and even more preferably at most 45% by weight of raw clay matrix.

Thus, in particular, a masonry unit according to the invention, in particular the compressed concrete block according to the invention, may comprise between 1 and 90% by weight of raw clay matrix, for example between 3 and 90% by weight of raw clay matrix, preferably between 3 and 50% by weight or between 3 and 40% by weight of raw clay matrix, more preferably between 4 and 35% by weight of raw clay matrix.

Preferably, the raw clay matrix of a masonry unit according to the invention comprises at least 20% by weight of smectite, illite and/or kaolinite, for example at least 30% by weight of smectite, illite and/or kaolinite, preferably at least 40% by weight of smectite, illite and/or kaolinite, more preferably at least 50% by weight of smectite, illite and/or kaolinite, preferably at least 40% by weight of smectite, illite and/or kaolinite, more preferably at least 50% by weight of smectite, illite and/or kaolinite and even more preferably at least 60% by weight of smectite, illite and/or kaolinite. The percentage by weight corresponds to the cumulative percentage of smectite, Illite and Kaolinite.

In particular, a clay matrix according to the invention may comprise between 20 and 80% by weight of smectite, Illite and/or Kaolinite, preferably between 30 and 70% by weight of smectite, Illite and/or Kaolinite or between 40 and 60% by weight of smectite, Illite and/or Kaolinite, more preferably between 40 and 60% by weight of smectite, Illite and/or Kaolinite. Preferably, the smectite can be Montmorillonite.

More preferably, the raw clay matrix of a construction binder according to the invention comprises at least one raw clay from the smectite family and at least one other raw clay selected from Kaolinite, Illite, Chlorite and Vermiculite. Even more preferably, the raw clay matrix of a construction binder according to the invention comprises smectite and at least one other raw clay selected from Kaolinite, Illite, Bentonite, Montmorillonite, Chlorite and Vermiculite.

Preferably, the raw clay matrix may correspond at least in part to an excavated clay soil, preferably an uncalcined excavated clay soil, such as a raw excavated clay soil. In particular, in this case, the clay matrix may comprise particles larger than 2 μm, preferably larger than 20 μm, more preferably larger than 50 μm and for example larger than 75 μm as determined according to ASTM D422-63. Preferably, the clay matrix does not include aggregates larger than 2 cm as determined in accordance with standard NF EN 933-1.

The excavated clay soil may advantageously have been pre-treated, said pre-treatment being selected from: crushing, sorting, sieving and/or drying the excavated clay soil. The pre-treatment may, for example, comprise fractionation.

Advantageously, the clay matrix may comprise at least 2% by weight of silt particles, preferably at least 4% by weight, more preferably at least 6% by weight. Silt particles are in particular particles with a diameter of between 2 μm and 50 μm.

Advantageously, at least part of the raw clay matrix may correspond to crushed raw clay. Preferably, part of the raw clay matrix may have a D50 of less than or equal to 500 μm, preferably less than or equal to 250 μm, more preferably less than or equal to 100 μm or even more preferably less than or equal to 50 μm.

In addition, at least part of the raw clay matrix may have a D50 greater than or equal to 0.1 μm, preferably greater than or equal to 1 μm, more preferably greater than or equal to 10 μm or even more preferably greater than or equal to 20 μm, more preferably greater than 40 μm. This reduces the strain on industrial production tools dedicated to grinding.

More preferably, at least part of the raw clay matrix may have a D50 between 10 μm and 500 μm, preferably between 15 μm and 200 μm, more preferably between 20 μm and 100 μm or even more preferably between 20 μm and 50 μm. The presence of clay crushed to such diameters can improve the compaction of compressed concrete blocks according to the invention.

The use of crushed raw clay with a controlled grain size is particularly important when preparing compressed concrete blocks from excavated soil (also known as site soil). Thus, a compressed concrete block according to the invention can advantageously comprise a raw clay matrix which is composed of raw clay from crushed excavated earth, for example with a D50 greater than 500 μm (it is not necessary to finely crush it) on the one hand and finely crushed raw clay (cf. D50 presented above) on the other.

Preferably, the raw clay matrix comprises kaolinite and/or illite. It is when the raw clay matrix comprises these clays (one or more) that the best results in terms of setting speed and mechanical strength at 20 hours are obtained.

In particular, a raw clay matrix according to the present invention may comprise at least 25% kaolinite and/or illite. Nevertheless, raw clay matrices comprising a majority of kaolinite and/or illite will be preferred in the context of the present invention. This may, for example, correspond to a clay matrix comprising more than 25% kaolinite and more than 25% illite, or a clay matrix comprising more than 40% kaolinite and more than 10% illite. Thus, a raw clay matrix according to the present invention will preferably comprise at least 50% by dry weight of kaolinite and/or illite, more preferably at least 70% by dry weight of kaolinite and/or illite.

In particular, a clay matrix according to the invention may comprise between 20 and 80% by weight of kaolinite and/or illite, preferably between 30 and 70% by weight of kaolinite and/or illite or between 40 and 60% by weight of kaolinite and/or illite, more preferably between 40 and 60% by weight of kaolinite and/or illite. When calculating the weight, the weight of kaolinite should preferably be added to the weight of illite to determine whether the clay matrix in question corresponds to a clay matrix according to the invention.

In particular, the raw clay matrix comprises smectite, preferably montmorillonite. The smectite family includes in particular montmorillonites and bentonite. In particular, the clay matrix comprises at least 10% by weight of smectite, preferably montmorillonite, more preferably at least 20% by weight. In fact, if the raw clay matrix comprises at least one raw clay from the smectite family and in particular when the at least one raw clay from the smectite family represents more than 20% by weight of the raw clay matrix, preferably at least 30% by weight of the raw clay matrix, then the compressed concrete block formed combines mechanical properties and moisture buffer value. This is particularly the case when the aggregates include plant aggregates.

### Calcined Metal Oxide Composition

Without being limited by theory, the metal oxide composition calcined according to the invention enables the bonds between the clay sheets to be strengthened so as to provide the compressed concrete block with its mechanical properties.

A calcined metal oxide composition advantageously comprises metal oxides selected from: iron oxides such as FeO, Fe₃O₄, Fe₂O₃, alumina Al₂O₃, manganese (II) oxide MnO, titanium (IV) oxide TiO₂, magnesium oxide MgO and mixtures thereof.

A calcined metal oxide composition may also comprise aluminosilicates.

The calcined metal oxide composition is, for example, selected from blast furnace slag, pozzolans such as volcanic ash, fly ash, silica fume or metakaolin, plant material ash such as rice ash, bauxite residues or combinations thereof. In particular, the composition of silicate and metal oxides is for example selected from blast furnace slag, pozzolans such as volcanic ash, fly ash, silica fume, plant matter ash such as rice ash, bauxite residues or combinations thereof.

Preferably, the metal oxides are transition metal oxides. The metal oxides can preferably be derived from a blast furnace slag composition, for example formed during the production of cast iron from iron ore.

The inventors have identified the importance of the mass quantity of metal oxides in combination with the raw clay matrix. Preferably, the masonry unit comprises at least 1% by dry weight of metal oxides, more preferably at least 2% by weight, even more preferably at least 3% by weight.

For example, a masonry unit according to the invention may comprise at least 2% by dry weight of a blast furnace slag composition. Advantageously, a masonry unit according to the invention will further comprise at least 3% by weight of at least one metal oxide corresponding to the oxide of a metal having at least two valence electrons. Preferably, the at least 3% by weight can be formed from several different metal oxides. These metal oxides may come from several sources. Preferably, the metal oxides formed with a metal having at least two valence electrons will be contained in the activating composition and/or in the calcined metal oxide composition. Preferably, the masonry unit according to the invention comprises at least 3% by weight of at least one metal oxide corresponding to the oxide of a metal having at least two valence electrons, more preferably at least 4% by weight. This may make it possible to increase the mechanical compressive strength of a masonry unit (e.g., compressed concrete block) according to the invention. A binder for a masonry unit according to the invention preferably comprises at least 5% by dry weight of metal oxides, more preferably at least 10% by dry weight of metal oxides and even more preferably at least 15% by dry weight of metal oxides.

Nevertheless, in contrast to other technical solutions that favor very high concentrations of blast furnace slag, fly ash or metakaolin, the inventors of the present invention have determined that it is preferable not to exceed certain concentrations. Thus, a binder for a masonry unit according to the invention preferably comprises no more than 70% by dry weight of metal oxides, more preferably no more than 60% by dry weight of metal oxides and even more preferably no more than 50% by dry weight of metal oxides. Similarly, by way of example, a binder for a masonry unit according to the present invention may comprise less than 30% by dry weight of metal oxides, preferably less than 20%, more preferably less than 10%.

In addition, the inventors have identified that certain values of the ratio between the mass quantity of calcined metal oxide composition and the mass quantity of raw clay matrix make it possible to improve the performance of a compressed concrete block thus formed. Advantageously, the calcined metal oxide composition and the raw clay matrix are mixed to form a binder for masonry unit concrete in such a way that a mass ratio of the calcined metal oxide composition to the raw clay matrix is between 0.2 and 3, preferably 0.4 and 2.5, more preferably 0.5 and 2. In particular, the calcined metal oxide composition and the raw clay matrix are mixed to form a masonry unit concrete binder such that a mass ratio of metal oxides to clay content is between 0.2 and 3, preferably 0.4 and 2.5; more preferably 0.5 and 2; and even more preferably 0.66 and 2.

In particular, the calcined metal oxide composition represents from 20% to 70% by dry weight of the binder constituting the concrete of the masonry unit. Preferably, the calcined metal oxide composition represents from 30% to 45% by dry weight of the binder constituting the concrete of the masonry unit. More preferably, the calcined metal oxide composition represents from 55% to 70% by dry weight of the binder constituting the concrete of the masonry unit.

For example, a masonry unit according to the invention, in particular the compressed concrete block according to the invention, comprises at least 1% by weight of a calcined metal oxide composition, preferably at least 2% by weight of a calcined metal oxide composition, more preferably at least 3% by weight of a calcined metal oxide composition and even more preferably at least 4% by weight of a calcined metal oxide composition. For example, at least 5% by weight of a calcined metal oxide composition or at least 10% by weight of a calcined metal oxide composition.

### Alkaline Activating Composition

Without being limited by theory, the activating composition in combination with the calcined metal oxide composition, preferably reinforced by the deflocculating agent, will enable the constitution of a network between the clay sheets which will provide its mechanical properties to the compressed concrete block according to the invention. Thus, advantageously, the masonry unit, and preferably the compressed concrete block, comprises an alkaline-activating composition. In particular, the concrete of the compressed concrete block according to the invention has been formed from a binder incorporating an alkaline-activating composition.

Advantageously, the activating composition is an alkaline activating composition. It therefore preferably comprises at least one base, such as a weak base or a strong base. The alkaline activating composition can preferably comprise one or more compounds with a pKa greater than or equal to 8, more preferably greater than or equal to 10, more preferably greater than or equal to 12, even more preferably greater than or equal to 14.

For example, the activating composition may comprise sulfates, hydroxides, carbonates, silicates, lactates, organophosphates, lime or combinations thereof.

Preferably, the activating composition comprises hydroxides and silicates. In particular, the activating composition may comprise a mixture of sodium hydroxide and sodium silicate. When the activating composition comprises silicates, the percentage of silicate in the masonry unit mixture originating from the activating composition and the percentage of silicate in the masonry unit mixture originating from the calcined metal oxide composition are counted separately.

In particular, the activating composition may comprise a mixture of sodium sulfate and sodium chloride.

Preferably, the activating composition comprises silicates and carbonates. In particular, the activating composition may comprise a mixture of sodium or potassium silicate and sodium or potassium carbonate.

More preferably, the alkaline activating composition comprises hydroxides.

Advantageously, the activating composition comprises an oxide of a metal having at least two valence electrons. In particular, the activating composition may comprise at least 40% by weight of at least one metal oxide corresponding to the oxide of a metal having at least two valence electrons. For example, the at least 40% by weight may correspond to several different metal oxides. However, preferably when the activating composition is an alkaline activating composition, it may comprise a single oxide of a metal having at least two valence electrons or more than 50% by weight of this metal oxide.

Preferably, the activating composition comprises at least 50% by weight of at least one metal oxide corresponding to the oxide of a metal, or alkaline-earth metal, having at least two valence electrons, more preferably at least 60% by weight; even more preferably at least 80% by weight.

The activating composition may comprise an organophosphorus compound such as sodium tripolyphosphate. Preferably the organophosphorus compound represents at least 2% by weight of the construction binder.

Preferably, the activating composition comprises a lactate such as sodium, potassium and/or lithium lactate.

As will be described below, the activating composition may be a liquid composition. In particular, the activating composition may be an aqueous composition. As will be described later, its use can be combined with the addition of water when forming a masonry unit mixture. Alternatively, however, the activating composition may be in solid form, e.g., in powder form. The indicated percentage of alkaline activating composition corresponds to the dry weight of the composition.

The activating composition is, for example, present in an amount of at least 0.1% by dry weight of the masonry unit, preferably at least 0.2% by dry weight of the masonry unit.

Preferably, the binder used to form the concrete of the masonry unit comprises from 0.2% to 50% by dry weight of an activating composition. More preferably, it comprises from 2% to 40% by dry weight of an activating composition. Even more preferably, it comprises from 10% to 25% of an activating composition.

As will be illustrated in the examples, the masonry binder may comprise from 20% to 40% by weight of an alkaline activating composition. This is particularly the case when the alkaline-activating composition comprises hydroxides and silicates. Alternatively, the construction binder-based compressed concrete block may comprise from 2% to 10% by dry weight of an activating composition. This is particularly the case when the alkaline activating composition comprises carbonates.

The binder for the masonry unit, or the binder for the compressed concrete block, when its preparation has incorporated the addition of an alkaline activating composition, will preferably comprise at least 0.1% by weight of sodium or potassium, more preferably at least 0.2% by weight of sodium or potassium.

### Deflocculant

As discussed and presented in the examples, the present invention does not require the mandatory presence of deflocculants to enable the manufacture of compressed concrete blocks meeting market expectations. However, the presence of one or more deflocculants can improve the manufacturing performance of compressed concrete blocks according to the invention. Thus, advantageously, the masonry unit, and preferably the compressed concrete block, comprises a deflocculant, advantageously an organic deflocculant.

Numerous compounds can act as deflocculants and many are generally known to those skilled in the art.

In the context of the invention, the deflocculating agent is in particular a non-ionic surfactant such as a polyoxyethylene ether. The polyoxyethylene ether may, for example, be selected from: a lauryl poly(oxyethylene) ether.

The deflocculating agent can also be an anionic agent such as an anionic surfactant. In particular, the anionic agent may be selected from: alkylaryl sulfonates, aminoalcohols, fatty acids, humates (e.g., sodium humates), carboxylic acids, lignosulfonates (e.g., sodium lignosulfonates), polyacrylates, carboxymethylcelluloses and mixtures thereof.

The deflocculating agent can also be a polyacrylate. It can then be selected, for example, from sodium polyacrylate and ammonium polyacrylate.

The deflocculating agent can also be an amine selected, for example, from: 2-amino-2-methyl-1-propanol; mono-, di- or triethanolamine; isopropanolamines (1-amino-2-propanol, diisopropanolamine and triisopropanolamine) and N-alkylated ethanolamines.

Alternatively, the deflocculating agent can be a mixture of compounds, such as a mixture comprising at least two compounds selected from: non-ionic surfactant, anionic agent, polyacrylate, amine and organophosphorus compound.

The deflocculating agent is preferably an organic deflocculating agent. According to the present invention, an organic deflocculating agent comprises at least one carbon atom and preferably at least one carbon-oxygen bond. Preferably, the organic deflocculating agent is selected from: a lignosulphonate (e.g., sodium lignosulphonate), a polyacrylate, a humate, a polycarboxylate such as an ether polycarboxylate, and mixtures thereof. More preferably, the deflocculating agent comprises a humate, a lignosulphonate and/or a polyacrylate.

The deflocculating agent is preferably used in the form of a salt. However, the invention is not limited to the aforementioned deflocculating agents or their salts. However, the invention is not limited to the above-mentioned organic deflocculating agents. Any type of organic deflocculating agent known to those skilled in the art may be used in place of the aforementioned deflocculating agents.

The deflocculating agent may, for example, represent from 0% to 5% by dry weight of the binder for masonry unit concrete. Indeed, in a method according to the invention, there may be no deflocculating agent. Preferably, the deflocculating agent represents from 0.1% to 3% by dry weight of the construction binder. Even more preferably, the deflocculating agent represents from 0.2% to 1% by dry weight of the binder for masonry unit concrete.

In particular, the deflocculating agent represents at least 0.1% by dry weight of the raw clay matrix, preferably at least 0.2% by dry weight of the raw clay matrix, more preferably at least 0.3% by dry weight of the raw clay matrix, even more preferably at least 0.4% by dry weight of the raw clay matrix, and for example at least 0.5% by dry weight of the raw clay matrix.

In particular, in the compressed concrete block, the deflocculating agent represents at least 0.02% by dry weight, preferably at least 0.05% by dry weight, more preferably at least 0.07% by dry weight.

In addition, the masonry unit, and preferably the compressed concrete block, may comprise other additives such as glycerine, accelerating agents, air entraining agents, foaming agents, wetting agents, or shrinkage control agents.

### Aggregates

As already mentioned, the compressed concrete block according to the invention comprises aggregates. Classically, the aggregates may be natural aggregates, artificial aggregates or recycled aggregates.

The aggregates may also comprise mineral aggregates, i.e., mainly composed of mineral material and/or plant aggregates, i.e., mainly composed of material of plant origin. The aggregates may also comprise marine aggregates, i.e., mainly made up of organic or inorganic material from the seabed, such as siliceous aggregates and calcareous substances (e.g., maerl and shell sands).

Mineral aggregates may, for example, include sand, chippings, gravels, fillers (or fine materials), powders, fossilized waste and combinations thereof.

In particular, when the compressed concrete block according to the invention comprises mineral aggregates, it preferably comprises at least 50% by weight of mineral aggregates, preferably at least 60% by weight of mineral aggregates, more preferably at least 70% by weight of mineral aggregates, and even more preferably at least 80% by weight of mineral aggregates. Generally, when mineral aggregates are used, the compressed concrete block according to the invention will preferably comprise at most 95% by weight of mineral aggregates, more preferably at most 90% by weight of mineral aggregates. For example, the compressed concrete block according to the invention may preferably comprise between 50% and 95% by weight of mineral aggregates, and more preferably between 60% and 90% by weight of mineral aggregates.

Plant aggregates may, for example, include wood (shavings or fibers), hemp, straw, hemp chenevotte, miscanthus, sunflower, typha, corn, flax, rice husks, wheat husks, rapeseed, algae, bamboo, cellulose wadding, defibered fabric and combinations thereof.

In particular, when the compressed concrete block according to the invention comprises plant aggregates, it preferably comprises at least 10% by weight of plant aggregates, preferably at least 15% by weight of plant aggregates, more preferably at least 20% by weight of plant aggregates, and even more preferably at least 25% by weight of plant aggregates. Generally, when plant aggregates are used, the compressed concrete block according to the invention will preferably comprise at most 60% by weight of plant aggregates, and more preferably at most 50% by weight of plant aggregates. For example, the compressed concrete block according to the invention may preferably comprise between 10% and 50% by weight of plant aggregates, and more preferably between 15% and 35% by weight of plant aggregates. When using plant aggregates in the compressed concrete block according to the invention, they can be combined with mineral aggregates such as sand. This can improve mechanical performances.

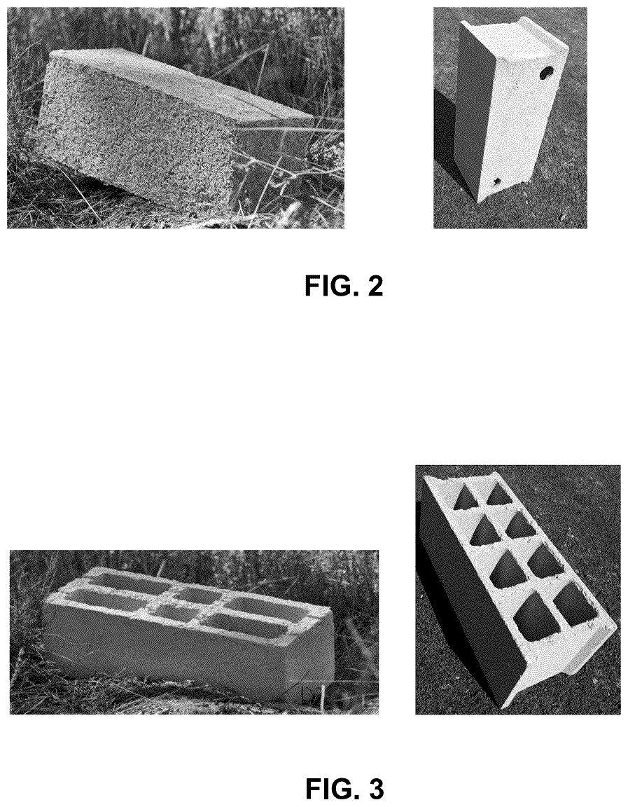

In several embodiments, and in particular when the compressed concrete blocks include plant aggregates, they can have a water buffer value, measured at the earliest 10 days after manufacture, of at least 0.75; preferably at least 1. Thus, such compressed concrete blocks make it possible to combine mechanical properties, compactability, a low carbon footprint and water buffer capacity improving the summer comfort of homes. Moreover, these materials have a remarkable aesthetic appeal (see FIGS. 2 and 3).

According to another aspect, the invention relates to a preparation method of masonry units, in particular a preparation method of compressed concrete blocks with a basis weight less than or equal to 600 kg/m².

A preparation method of masonry units according to the invention can be implemented with devices or systems usually used for preparing compressed concrete blocks.

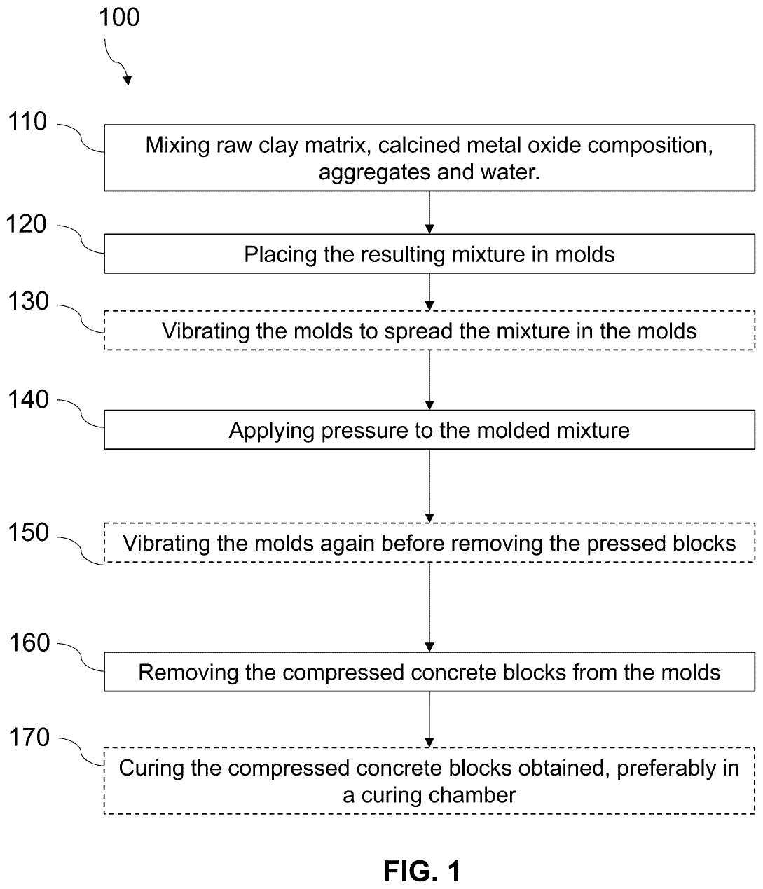

As illustrated in FIG. 1, a preparation method 100 according to the invention will comprise the following steps: mixing 110 a raw clay matrix, a calcined metal oxide composition and aggregates and water; placing 120 the resulting mixture in molds; applying 140 pressure to one surface of the molded mixture, preferably the top surface; removing 160 the pressed blocks from the molds.

In addition, the preparation method may include the steps of vibrating 130 the molds to spread the mixture in the mold and vibrating 150 the molds again before removing the pressed blocks; and curing 170 the compressed concrete blocks obtained, preferably in a curing chamber.

A preparation method 100 according to the invention comprises a mixing step 110 of a raw clay matrix, a calcined metal oxide composition, aggregates and water.

In particular, the mixing step may be carried out in several sub-steps. For example, in a first step, the preparation method 100 may comprise a premixing of a raw clay matrix and a calcined metal oxide composition. In addition, during this premix, the method according to the invention may advantageously include the addition of an activating composition, preferably an alkaline activating composition. This premixture can be hydrated to form a construction binder.

As already mentioned, the inventors have identified that certain ratio values between the mass quantity of calcined metal oxide composition and the mass quantity of raw clay matrix improve the performance of a compressed concrete block thus formed. Thus, in a preferred manner, the method according to the invention can comprise a mixture of a calcined metal oxide composition and a raw clay matrix so that a mass ratio of the calcined metal oxide composition to the raw clay matrix is between 0.2 and 5, preferably 0.4 and 2.5 or 0.7 and 4, more preferably 0.8 and 3 or between 0.5 and 2.

Once the construction binder has been formed, the method may include the addition of aggregates and, optionally, water. When forming a mixture for compressed concrete blocks, the mixture to be placed in the molds is weakly hydrated with a water to dry matter weight ratio of the composition preferably adjusted to a value between 0.3 and 0.6 and more preferably between 0.3 and 0.45.

A preparation method 100 according to the invention includes a step to place 120 the mixture obtained in molds. The molds will shape the compressed concrete block and form its cavities where appropriate. In some cases, the step of placing 120 the resulting mixture in the molds may be preceded by a step of extruding the mixture.

A preparation method 100 according to the invention may at this point include a step to vibrate 130 the molds so as to spread the mixture in the molds. In this way, the mixture is evenly distributed in the mold. The vibration step can be carried out with the parameters usually used in the field, in particular, the vibration frequency can vary according to the targeted properties.

A preparation method 100 according to the invention comprises a step of applying 140 a pressure to the molded mixture, for example on a surface of the molded mixture, preferably on the top surface. The pressure may be applied by conventional means for forming compressed concrete blocks. For the purposes of the invention, applying pressure to one surface does not exclude the possibility of applying pressure to several surfaces. For example, pressure can be applied to several surfaces of the molded mix. The pressure applied may typically correspond to a pressure of at least 50 kg/m² for at least 15 seconds.

Compression can be achieved, for example, using a fixed concrete press. In this case, the press can be associated with a concrete batching plant equipped with probes for monitoring the hydrometry of the materials in order to have good control over concrete consistencies. Production capacities may vary depending on the product, but the process according to the invention is advantageously configured to produce at least 15,000 compressed concrete blocks over 12 hours.

Alternatively, a manual or laying press can be used. It can, for example, be associated with a concrete production unit in line with requirements and capable of producing “controlled” concretes.

Advantageously, a preparation method 100 according to the invention may include a step aimed at vibrating 150 the molds again before removing the compressed concrete blocks from the molds. This step facilitates removal of the molds. The vibration step can be carried out using the parameters normally used in the field.

The method also includes a step of removing 160 the compressed concrete blocks from the molds. This step is preferably carried out immediately after compressing the mixture or immediately after re-vibrating the mold. For example, the step to remove the compressed concrete blocks can be carried out less than 5 minutes, preferably less than 2 minutes, more preferably less than 1 minute, even more preferably less than 30 seconds after the step to place 120 the mixture in the molds. Once demolded, the building blocks advantageously have a basis weight less than or equal to 600 kg/m².

The method can then include a curing step 170 to mature the compressed concrete blocks obtained and, if necessary, place them in a curing chamber. This step gives the compressed concrete blocks time to mature and improves their mechanical, physicochemical and hygrometric properties. In particular, this step, also known as the curing step, can increase the compressive strength of the blocks obtained. For example, this curing step can be less than 28 days, preferably less than 15 days, more preferably less than 10 days and even more preferably less than or equal to 7 days. Indeed, compressed concrete blocks according to the present invention have the advantage of reaching a plateau for their compressive strength value more quickly. Thus, in addition to a lower carbon footprint, compressed concrete blocks according to the present invention have advantageous characteristics for the industrialization of their production and the reduction of operational preparation costs.

Preferably, the curing step may involve heat treatment at a temperature above 25° C., more preferably above 30° C. However, in order to maintain a favorable energy balance, the heat treatment that may be carried out as part of the curing step is performed at a temperature of less than 100° C., preferably less than or equal to 80° C. For example, the heat treatment is carried out at a temperature of between 20° C. and 90° C., with the thermal curing step preferably being carried out at a temperature of between 25° C. and 80° C.; even more preferably between 25° C. and 65° C. In addition, the heat treatment can be carried out over the entire curing step or over a shorter period. For example, heat treatment is preferably carried out over a period of less than 20 hours, more preferably less than 15 hours, and even more preferably less than 10 hours. Ideally, the heat used for the curing step comes from the recovery of waste heat from other surrounding processes.

In addition, the curing step may be carried out in water or involve storage in a humid environment (e.g., humidity greater than 80%; preferably greater than 85% relative humidity) or include one or more steps for wetting the compressed concrete blocks.

### EXAMPLES

### Preparation of a Mixture for a Construction Unit:

In all the examples presented below, the formulations according to the invention are prepared according to an identical protocol, i.e., a dry premixture is made between a raw clay matrix, a calcined metal oxide composition, and aggregates in predetermined quantities, then, after a first mixing, water is added.

The mixture was then thoroughly mixed for at least 20 seconds after it had been placed in suitable molds.

The water-to-dry matter weight ratio of the composition is adjusted to a value between 0.04 and 0.07. In a particular example, the binder for concrete masonry units comprises 35% by weight of raw clay matrix, 65% by weight of calcined metal oxide composition; and the dry mixture for concrete masonry units comprises 90% by weight of aggregates and 10% by weight of binder. This mixture is topped up with water to give a weight ratio of water to binder solids adjusted to a value of 0.06.

The resulting building component mixture is then placed in a mold, compressed, demolded and left to cure at room temperature, i.e., around 20 degrees Celsius, for seven days.

Alternatively, the mixture can be placed in a mold, compressed, demolded and left to cure.

### Methodology for Measuring the Mechanical Properties of Mixtures for Construction Units:

Once curing is complete, mechanical strength is measured. The mechanical strength of a masonry unit is defined as its compressive strength, measured in accordance with NF EN 771-3+A1/CN and expressed in Mega Pascal (MPa).

Comparison of the Construction Units According to the Invention with Known Construction Units:
Table 2 below shows the properties obtained for different types of compressed concrete block.

TABLE 2

| | Reference Block | Reference Block | |
|---|---|---|---|
| | with Fly | based on Portland | |
| | Ash | Cement | BLOCK MTU01 |
| Size | 400 mm × 200 | 200 mm × 200 | 200 mm × 200 |
| | mm × 100 mm | mm × 500 mm | mm × 500 mm |
| Density of | 1850-2000 | 1600 to 2300 | 350 to 2000 |
| Dry Material | kg/m³ | kg/m³ | kg/m³ |
| Dry Weight | 18 kg | 18 to 25 kg | 6 to 25 kg |
| Compressive | 6 to 8 MPa | 4 to 12 MPa | 4 to 12 MPa |
| Strength | | | |
| Thermal | 1.1-1.2 W/mK | 0.6-1.2 W/mK | <1.2 W/mK |
| Conductivity | | | |
| Thermal r | <0.1 m²K/W | 0.1 to 0.5 m²K/W | 0.05 to 0.5 m²K/W |
| Resistance | | | |
| Shrinkage | Less than 0.10% | Less than 0.10% | Less than 0.10% |
| During | | | |
| Drying | | | |
| CO₂ Reduction | Up to 70% | 0% | Up to 80% |
| compared to a Block | | | |
| formulated with | | | |
| 100% Portland | | | |
| Cement Binder | | | |

Table 2 above illustrates that the compressed block according to the invention, while not containing Portland cement or clinker, achieves equivalent performance to products containing clinker and having a high carbon footprint.

TABLE 3

| | MTU-M1 | MTU-M2 | MTU-V1 | MTU-V2 |
|---|---|---|---|---|
| Raw Clay | 4% | 4% | 27.6% | 27.6% |
| Matrix (A) | | | | |
| Calcined | 3% | 3% | 20.7% | 20.7% |
| metal oxide | | | | |
| composition (B) | | | | |
| Ratio A/B | 4/3 | 4/3 | 4/3 | 4/3 |
| Aggregates | 89% - Mineral | 89% - Mineral | 30% - Plant | 30% - Plant |
| | Origin | Origin | Origin | Origin |
| Alkaline | 3% | 3% | 20.7% | 20.7% |
| Activating | | | | |
| Composition | | | | |
| Deflocculant in | 0% | 1% | 0% | 1% |
| relation to Raw | | | | |
| Clay Matrix | | | | |
| Volume of | 30% | 30% | 0% | 0% |
| Cavities | | | | |
| 10-day | 4 MPa | 5 MPa | 0.5 MPa | 0.7 MPa |
| Compressive | | | | |
| Strength | | | | |
| Dimension | 15*20*50 cm | 15*20*50 cm | 15*20*50 cm | 15*20*50 cm |
| Basis Weight | 140 kg/m² | 140 kg/m² | 50 kg/m² | 62 kg/m² |
| MBV | nd | nd | 1.1 | 1.2 |
| Friability | High | Absent | Very High | Medium |

Table 3 above illustrates the properties of 4 compressed concrete blocks according to the present invention as a function of the dry weight content of certain of its constituents. The compressed block according to the invention, while not containing Portland cement or clinker, achieves equivalent performance to products containing clinker and having a high carbon footprint.

In addition, the presence of deflocculants can reduce the friability of a compressed concrete block obtained according to the present invention.

TABLE 4

| | MTU-M1 | MTU-M3 | MTU-M2 | MTU-M4 |
|---|---|---|---|---|
| Raw Clay | 4% | 4% | 4% | 4% |
| Matrix (A) | | | | |
| D50 of Raw | <500 μm | >2 mm | <500 μm | >2 mm |
| Clay Matrix | | | | |
| Calcined | 3% | 3% | 3% | 3% |
| Metal Oxide | | | | |
| Composition (B) | | | | |
| Ratio A/B | 4/3 | 4/3 | 4/3 | 4/3 |
| Aggregates | 89% - Mineral | 89% - Mineral | 89% - Mineral | 89% - Mineral |
| | Origin | Origin | Origin | Origin |
| Alkaline | 3% | 3% | 3% | 3% |
| Activating | | | | |
| Composition | | | | |
| Deflocculant in | 0% | 0% | 1% | 1% |
| relation to Raw | | | | |
| Clay Matrix | | | | |
| (by weight) | | | | |
| Volume of the | 30% | 30% | 30% | 30% |
| Cavities | | | | |
| 10-day | 4 MPa | 1 MPa | 5 MPa | 1 MPa |
| Compressive | | | | |
| Strength | | | | |
| Basis Weight | 140 kg/m² | 135 kg/m² | 140 kg/m² | 135 kg/m² |
| MBV | nd | nd | nd | nd |
| Friability | High | Very High | Absent | Very High |

Table 4 above illustrates the properties of 4 compressed concrete blocks according to the present invention. The MTU-M1 and MTU-M2 compressed blocks, which are made with a crushed clay matrix, have a much higher compressive strength than the MTU-M3 and MTU-M4 compressed blocks, which are made with an uncrushed clay matrix with a 050 greater than 2 mm. In addition, the use of a crushed clay with a 050 of less than 500 μm can reduce the number of non-conformities in the blocks produced and homogenize intra- and inter-batch performance.

In addition, the presence of a deflocculating agent reduces the friability of the compressed block when a crushed clay matrix is used, whereas it has no significant effect when the clay matrix used is not crushed.

The invention may be the subject of numerous variants and applications other than those described above. In particular, unless otherwise indicated, the various structural and functional features of each of the implementations described above are not to be considered as combined and/or closely and/or inextricably linked to one another, but rather as mere juxtapositions. Furthermore, the structural and/or functional features of the different implementations described above may be subject in whole or in part to any different juxtaposition or combination.

1. A preparation method for a compressed concrete block with a basis weight less than or equal to 600 kg/m², said method comprising the following steps:
mixing a raw clay matrix, a calcined metal oxide composition, aggregates and water; at least part of the raw clay matrix corresponding to crushed raw clay and having a D50 less than or equal to 500 μm as determined according to ASTM D422-63;
placing the resulting mixture in a mold;
applying pressure to a surface of the molded mixture; and
removing the resulting compressed concrete blocks from the molds.

2. The preparation method for a compressed concrete block according to claim 1, wherein the mixing step comprises a step of premixing the raw clay matrix and the calcined metal oxide composition to form a construction binder.

3. The preparation method for a compressed concrete block according to the claim 2, wherein the construction binder is mixed with the aggregates and the water during the mixing step, at a construction binder content less than or equal to 250 kg/m³ of mixture volume.

4. The preparation method for a compressed concrete block according to claim 1, wherein the mixing step also includes the addition of an activating composition.

5. The preparation method for a compressed concrete block according to claim 1, wherein the mixing step also includes the addition of a deflocculant.

6. The preparation method for a compressed concrete block according to claim 1, wherein a weight ratio of calcined metal oxide composition to raw clay matrix is between 0.5 and 2.5.

7. The preparation method for a compressed concrete block according to claim 1, further comprising a heating step, between 20° C. and 90° C.

8. The preparation method for a compressed concrete block according to claim 1, wherein the mixing step involves extruding the mixture.

9. The preparation method for a compressed concrete block according to claim 1 wherein the raw clay matrix comprises at least one clay selected from: Kaolinite, Bentonite, Montmorillonite, Illite, Smectite, Chlorite, Muscovite, Hallocyte, Sepiolite, Attapulgite and Vermiculite.

10. The preparation method for a compressed concrete block according to claim 1, wherein the raw clay matrix comprises at least one raw clay from the smectite family, and the at least one raw clay from the smectite family accounts for more than 20% by weight of the raw clay matrix.

11. The preparation method for a compressed concrete block according to claim 1, wherein the raw clay matrix comprises at least 50% kaolinite and/or illite by dry weight.

12. The preparation method for a compressed concrete block according to claim 1, wherein at least part of the raw clay matrix corresponds to excavated soil.

13. The preparation method for a compressed concrete block according to claim 1, wherein at least part of the raw clay matrix corresponds to crushed raw clay and has a D50 greater than or equal to 0.1 μm as measured by ASTM D422-63.

14. The preparation method for a compressed concrete block according to claim 1, wherein at least part of the raw clay matrix corresponds to crushed raw clay and has a D50 of between 10 μm and 500 μm as measured by ASTM D422-63.

15. The preparation method for a compressed concrete block according to claim 1, wherein the aggregates comprise mineral aggregates selected from fillers, powders, sand, chippings, gravel, fossilized aggregates and combinations thereof.

16. The preparation method for a compressed concrete block according to claim 1, wherein the mixture comprises at least 40% by weight of mineral aggregates.

17. The preparation method for a compressed concrete block according to claim 1, wherein the aggregates comprise biobased aggregates selected from wood shavings or fibers, hemp, straw, hemp chenevotte, miscanthus, sunflower, typha, maize, flax, rice husks, wheat husks, rapeseed, algae, bamboo, cellulose wadding, defibrated fabric, and combinations thereof.

18. The preparation method for a compressed concrete block according to claim 17, wherein the mixture comprises at least 10% by weight of biobased aggregates.

19. A compressed concrete block comprising a raw clay matrix, metal oxides and aggregates, said compressed concrete block having a basis weight less than or equal to 600 kg/m² and a thickness of at least 15 cm.

20. The compressed concrete block according to claim 19, wherein it has a basis weight less than or equal to 300 kg/m².

21. The compressed concrete block according to claim 19, wherein it comprises at least 1% by weight of divalent metal oxides.

22. The compressed concrete block according to claim 19, wherein it has one or more cavities with a volume greater than or equal to 2 cm³.

23. The compressed concrete block according to claim 19, wherein it has one or more cavities representing a total volume of at least 30% of the total volume of the compressed concrete block.

24. The compressed concrete block according to claim 19, wherein it has a moisture buffer value, measured at the earliest 10 days after manufacture, greater than or equal to 0.75.

25. The compressed concrete block according to claim 19, wherein it comprises at least 2% by weight of the raw clay matrix.

26. The compressed concrete block according to claim 19, wherein it comprises less than 2% by weight of Portland cement.

27. The compressed concrete block according to claim 19, wherein a mass ratio of metal oxides to the raw clay matrix is between 0.4 and 2.5.

28. The compressed concrete block according to claim 19, wherein the aggregates comprise mineral aggregates selected from fillers, powders, sand, chippings, gravel and combinations thereof.

29. The compressed concrete block according to claim 28, wherein it comprises at least 40% by weight of mineral aggregates.

30. The compressed concrete block according to claim 19, wherein the aggregates comprise a biobased aggregate selected from wood-shavings or fibers, hemp, straw, hemp chenevotte, miscanthus, sunflower, typha, corn, flax, rice husks, wheat husks, rapeseed, algae, bamboo, cellulose wadding, defibered fabric and combinations thereof.

31. The compressed concrete block according to claim 30, wherein it comprises at least 10% by weight of biobased aggregates.

32. The compressed concrete block according to claim 19, wherein it comprises a deflocculant.

33. Masonry construction comprising the compressed concrete block according to claim 19 with a mortar formulated from a raw clay-based binder.

34. The masonry construction according to claim 33, comprising a plurality of said compressed concrete block.

35. The masonry construction according to claim 34, wherein it takes the form of a facade wall or load-bearing wall.
